(19) United States
(12) Patent Application Publication
(10) Pub. No.: US 2025/0246025 A1
(43) Pub. Date: Jul. 31, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Hideki SORAKADO, Tokyo (JP)

(21) Appl. No.: 19/006,387

(22) Filed: Dec. 31, 2024

(30) Foreign Application Priority Data
Jan. 25, 2024 (JP) 2024-009316

(51) Int. Cl. G06V 40/40; G06V 10/60; G06V 40/16

(52) U.S. Cl. CPC G06V 40/45; G06V 10/60; G06V 40/172

(57) ABSTRACT

In an information processing apparatus, an image that includes a person to be authenticated is acquired, a contribution region within the image to be used in authenticating the person is identified, a determination region to be used for spoofing determination processing based on the identified contribution region is determined; and the spoofing determination processing for determining spoofing based on the determination region is executed.

### BACKGROUND OF THE INVENTION

### Field of the Invention

The present invention relates to an information processing apparatus, an information processing method, a storage medium, and the like.

### Description of the Related Art

Conventionally, there has been an attack attempting to perform authentication in an unauthorized manner by presenting an artifact imitating a living body to biometric authentication. For example, in the case of face authentication, there is an attack attempting to perform authentication by posing as another person by presenting a photograph and the like on which a face image is printed.

As a technology for detecting such an attack, there is a spoofing detection technology. In Japanese Patent No. 6,932,150, it is determined whether or not an input face image is a living body, thereby detecting whether or not spoofing has occurred.

However, there is a drawback in which it is erroneously determined that spoofing has occurred in a case in which there is accidental shielding without spoofing intention. For example, even in a case in which a mask, sunglasses, face paint, a beard, and the like are worn without spoofing intention, shielding occurs in a face region and a region in which skin is visible is reduced, and thus, there is a case in which it is erroneously determined that spoofing has occurred.

### SUMMARY OF THE INVENTION

In an information processing apparatus, an image that includes a person to be authenticated is acquired, a contribution region within the image to be used in authenticating the person is identified, a determination region to be used for spoofing determination processing based on the identified contribution region is determined; and the spoofing determination processing for determining spoofing based on the determination region is executed.

Further features of the present invention will become apparent from the following description of embodiments with reference to the attached drawings.

### BRIEF DESCRIPTION OF THE DRAWINGS

FIG. 1A is a block diagram showing an example of the hardware configuration of information processing apparatuses 100 and 300, and FIG. 1B is a block diagram showing an example of the functional configuration of an information processing apparatus 100.

FIG. 2A to FIG. 2D are flowcharts for explaining the operation of the information processing apparatus 100.

FIG. 3A is a block diagram illustrating an example of the functional configuration of the information processing apparatus 300. FIG. 3B and FIG. 3C are flowcharts for explaining the operation of the information processing apparatus 300.

FIG. 4A to FIG. 4D are flowcharts illustrating a flow of display processing and learning processing performed by the information processing apparatus 300.

FIGS. 5A to 5D are diagrams illustrating examples of a data format and display stored by the information processing apparatus 300.

FIG. 6 is a flowchart showing a flow of spoofing determination processing.

FIGS. 7A to 7E are explanatory diagrams of an example of creating a contribution region.

### DESCRIPTION OF THE EMBODIMENTS

Hereinafter, with reference to the accompanying drawings, favorable modes of the present invention will be described using embodiments. In each diagram, the same reference signs are applied to the same members or elements, and duplicate description will be omitted or simplified.

### First Embodiment

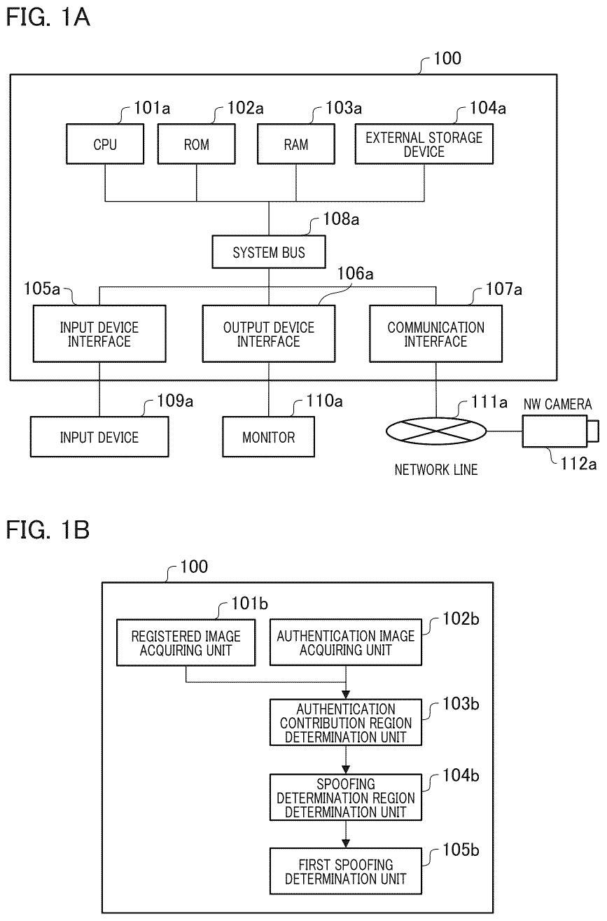

An example of the hardware configuration of an information processing apparatus according to the first embodiment will be explained with reference to the block diagram of FIG. 1A. FIG. 1A is a block diagram illustrating an example of the hardware configuration of the information processing apparatus 100 according to the first embodiment.

Reference numeral 101a denotes a CPU (Central Processing Unit) that controls the entire information processing apparatus 100, and reference numeral 102a denotes a ROM (Read Only Memory) that stores programs and parameters that do not need to be changed.

Reference numeral 103a denotes a RAM (Random Access Memory) that temporarily stores programs and data supplied from an external device and the like, and reference numeral 104a denotes an external storage device that includes a hard disk and a memory card fixedly installed in the information processing apparatus 100.

Note that the external storage device 104a may include an optical disk such as a Compact Disk (CD) that is attachable to and detachable from the information processing apparatus 100, a magnetic or optical card, an IC card, a memory card, and the like.

Reference numeral 105a denotes an input device interface that is connected to an input device 109a, for example, a pointing device, a mouse, and a keyboard that receives user operations and input data. Reference numeral 106a denotes an output device interface that is connected to a monitor 110a for displaying data held by the information processing apparatus 100 and supplied data.

Reference numeral 107a denotes a communication interface for connecting to a network line 111a such as the Internet, and connects to a network (NW) camera 112a via the network line 111a. The NW camera 112a is an image capturing apparatus that captures video images. A system bus 108a is a transmission line that communicably connects each unit of 101a to 107a.

Next, functions of the information processing apparatus of the first embodiment will be explained with reference to the block diagram of FIG. 1B. FIG. 1B is a functional block diagram illustrating a configuration example of the information processing apparatus 100 according to the first embodiment.

Note that some or all of the functional blocks as shown in FIG. 1B are realized by causing the CPU 101a and the like serving as a computer included in the information processing apparatus 100 to execute a computer program stored in a memory serving as a storage medium.

However, some or all of them may be realized by hardware different from the CPU 101a. As hardware different from the CPU 101a, a dedicated circuit (ASIC), a processor (reconfigurable processor, DSP), and the like can be used.

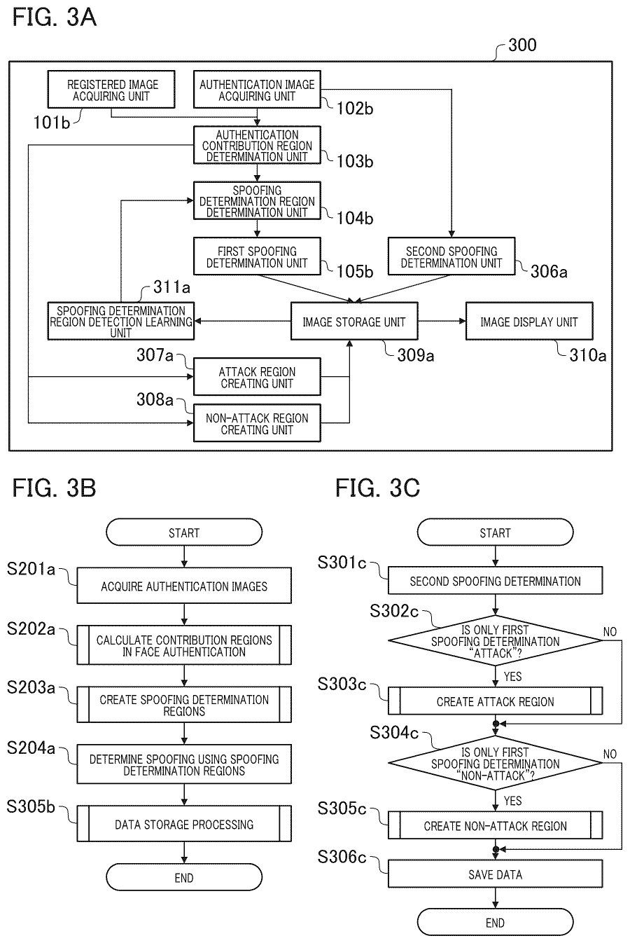

Additionally, each functional block as shown in FIG. 1B may not be incorporated in the same housing, and may be configured by separate devices connected to each other via a signal path. Note that the above explanation of FIG. 1 also applies to FIG. 3A.

The information processing apparatus 100 of the first embodiment performs spoofing determination on a face image. A registered image acquiring unit 101b acquires a plurality of face images registered in advance. These images are referred to as registered images. The registered images are stored in advance in the external storage device 104a. Note that the registered image acquiring unit 101b functions as a registered image acquiring unit that acquires a registered image of a person to be authenticated.

Each registered image may be held in association with a person ID for identifying a person. In addition, information such as the name of the person may also be stored in association. The storage method and the acquisition method of the registered image are not limited thereto.

An authentication image acquiring unit 102b acquires images such as a face image that includes a person to be authenticated. This image is referred to as an authentication image. The authentication image may be acquired via the network (NW) camera 112a and the like. Alternatively, a face image held in the external storage device 104a in advance may be used. Note that the acquisition method of authentication images is not limited thereto. In this context, the authentication image acquiring unit 102b functions as an acquiring unit that acquires images that include a person to be authenticated.

An authentication contribution region determination unit 103b determines which region of the authentication image acquired by the authentication image acquiring unit 102b is a region that contributes to face authentication (contribution region). The authentication contribution region determination unit 103b functions as a specifying unit that specifies a contribution region in the image used for authentication of a person. In the first embodiment, the contribution region is obtained by combining two broadly divided methods.

The first method is a method of removing a region that does not contribute to face authentication based on heuristics (empirical rules), machine learning, and the like. A region of a face shielded by a mask that includes a surgical mask, sunglasses, and the like is a region that does not contribute to face authentication. Accordingly, the first method sets regions other than those shielded by masks, surgical masks, sunglasses, and similar objects as the contribution region.

The second method is a method of obtaining a basis region in which the similarity between the registered image and the authenticated image is determined. Specifically, the second method is a method of determining a contribution region based on a region that contributes to the determination of the similarity between the authenticated image acquired by the authentication image acquiring unit 102b and the registered image acquired by the registered image acquiring unit 101b.

Specifically, as a face authentication method, there is a method of converting an image into feature vectors by a neural network and the like, and determining whether or not the same person appears in two images based on the similarity between the feature vectors of the registered image and the authentication image. In such a case, a region for determining the similarity between two feature vectors may be calculated and used as the basis region.

For example, in Document 1 (Jonathan R Williford, Brandon B May, and Jeffrey Byrne. Ignorable face recognition. In ECCV, pages 248 to 263. Springer, 2020.), a method of obtaining a basis region by adding noise to an authentication image is described.

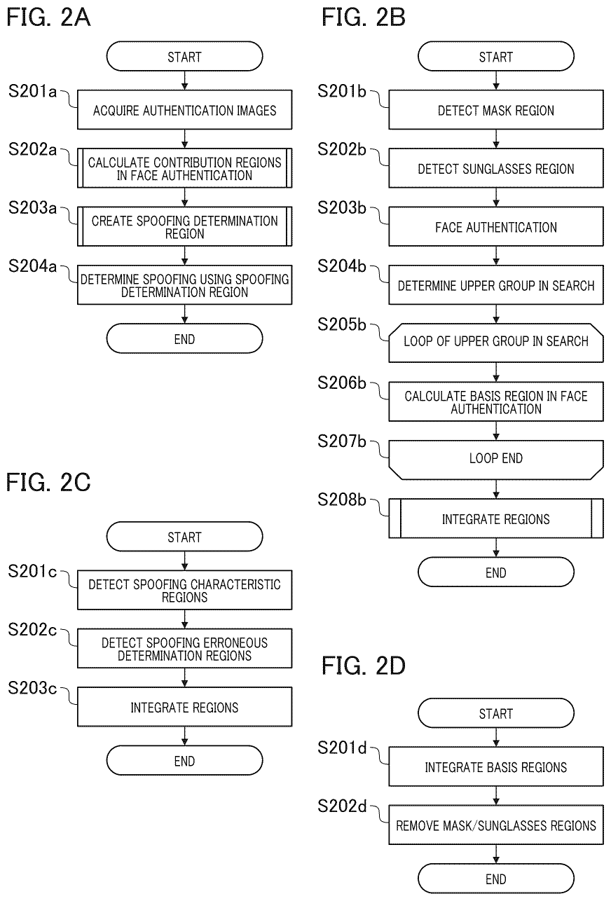

Such a method described in Document 1 may be used. Note that the method of calculating the basis region is not limited thereto. Additionally, in the first embodiment, although an example of obtaining a final contribution region by integrating regions obtained by the above-described two methods will be mainly explained, a detailed processing example will be described below with reference to FIG. 2B and the like.

In addition, a face image of a bare face without decoration such as a mask may be acquired from the registered image acquiring unit 101b. If there is a wearable object such as a mask in the registered image when the basis region that determines the similarity between the registered image and the authentication image is acquired, the wearable object contributes to the determination of the similarity.

Therefore, it is desirable that an image of bare face is used as a registered image. That is, it is desirable that the registered image acquiring unit 101b acquires an image of a person who does not wear a shielding object as a registered image. Accordingly, it is possible to prevent elements other than the face, such as a wearable object, from being included in the basis region.

A spoofing determination region determination unit 104b generates a spoofing determination region to be used for spoofing determination based on the contribution region obtained by the authentication contribution region determination unit 103b. In this context, the spoofing determination region determination unit 104b functions as a determination unit that determines a determination region to be used for spoofing determination processing based on the contribution region that has been specified by the specification unit.

Specifically, the spoofing determination region determination unit 104b adds the spoofing characteristic region to the spoofing determination region and excludes a region that induces erroneous spoofing determination from the spoofing determination region.

That is, the spoofing determination region determination unit 104b determines the determination region by adding the spoofing characteristic region having the spoofing characteristic to the contribution region. Additionally, the spoofing determination region determination unit 104b determines the determination region by excluding the spoofing erroneous determination region corresponding to predetermined conditions that induce the erroneous determination in the spoofing determination from the contribution region.

The spoofing characteristic region is a region in which characteristics of spoofing appear. When a photograph and the like in which a person is printed is taken by a camera, light may be reflected on the photograph. In contrast, a region and the like that is overexposed due to reflection is unlikely to become a basis region in face authentication and unlikely to remain as a contribution region.

Accordingly, the spoofing characteristic region is added to the spoofing determination region, so that the spoofing can be easily detected. Additionally, the spoofing characteristic region may include a region in which wrinkles, peeling, dirt, and the like in paper and the like are present, in addition to the reflection region.

That is, the spoofing characteristic region includes at least one of reflection, wrinkles, peeling, and dirt of the image of the person to be authenticated. Note that, as the spoofing characteristic region, a region that represents an artifact-like thing that does not appear in a living body is preferable.

Note that the reflection may be caused by eyeglasses and the like, and, in many cases, such reflection is not spoofing. Hence, the reflection region other than the eye may be set as the spoofing characteristic region. However, the spoofing characteristic region is not limited thereto.

Additionally, the spoofing erroneous determination region that induces spoofing erroneous determination also includes a region in which conditions such as a blur region or a region in which brightness are unfavorable. Although, in the case of face authentication, authentication with high robustness is possible even in a region in which conditions such as a blur region and a region in which brightness is unfavorable, in the spoofing determination, whether a living body or an artifact is determined based on a minute change in an image, and thus the robustness is lower than that of face authentication.

As a result, even a region in which the conditions are unfavorable for the spoofing determination becomes a region that contributes to the face authentication. Accordingly, in the first embodiment, a spoofing erroneous determination region in which conditions for the spoofing determination are unfavorable is excluded from the spoofing determination region, thereby reducing the erroneous determination in the spoofing determination.

That is, the spoofing erroneous determination region is excluded from the spoofing determination region based on the blur or brightness of the image of the person to be authenticated. Note that the spoofing erroneous determination region that induces erroneous determination is not limited thereto.

A first spoofing determination unit 105b determines whether or not the authentication image obtained by the authentication image acquiring unit 102b is spoofing by using the spoofing determination region determined by the spoofing determination region determination unit 104b. Specifically, there are various methods.

For example, as a “method of obtaining a spoofing score of an image”, there is Document 2 (A. George and S. Marcel, “On the Effectiveness of Vision Transformers for zero shot Face Anti-Spoofing,” 2021 IEEE International Joint Conference on Biometrics (IJCB), Shenzhen, China, 2021, pp. 1-8) and the like.

In this Document 2, a method of learning a neural network in advance so that a spoofing image and a non-spoofing image can be classified, and obtaining a spoofing score of an image using the learned neural network is described.

As a method of using the spoofing determination region in such a “method of obtaining a spoofing score of an image”, a method of blackening an authentication image other than the spoofing determination region and inputting the authentication image to the neural network is conceivable.

Alternatively, at the time of learning of the neural network, both the image and the spoofing determination region are provided as inputs to the neural network for learning. A method of obtaining a spoofing score by inputting both the spoofing determination region and the authentication image to the neural network, and the like is conceivable.

In contrast, as a “method of obtaining a spoofing score for each region of an image”, there is Document 3 (C.-Y. Wang, Y.-D. Lu, S.-T. Yang and S.-H. Lai, “PatchNet: A Simple Face Anti-Spoofing Framework via Fine-Grained Patch Recognition,” 2022 IEEE/CVF Conference on Computer Vision and Pattern Recognition (CVPR), New Orleans, La., USA, 2022, pp. 20249 to 20258) and the like.

In Document 3, an input image is divided into patches, and a spoofing score is obtained for each patch.

Additionally, as a “method of obtaining a spoofing score for each region of an image”, there are Document 4 (Z. Yu, J. Wan, Y. Qin, X. Li, S. Z. Li and G. Zhao, “NAS-FAS: Static-Dynamic Central Difference Network Search for Face Anti-Spoofing,” in IEEE Transactions on Pattern Analysis and Machine Intelligence, vol. 43, no. 9, pp. 3005 to 3023, 1 Sep. 2021) and the like.

In Document 4, a method of obtaining a spoofing score for each pixel, although the resolution is lower than that of an input image is described. As a method of using a spoofing determination region in such a “method of obtaining a spoofing score for each region of an image”, it is conceivable that a spoofing score of an image is determined by using a spoofing score for a region in a spoofing determination region.

For example, calculating statistics such as the average or maximum value of the spoofing score within the spoofing determination region may be considered. Alternatively, it is conceivable that when the input image is divided into patches, the patches are arranged so that the patches include many spoofing determination regions.

Then, a statistic of the obtained spoofing score for each patch may be calculated as the spoofing score of the image. However, the spoofing determination method using the spoofing determination region is not limited thereto.

Next, the spoofing determination processing in the first embodiment will be explained with reference to FIGS. 2A to 2D. FIGS. 2a to 2D are flowcharts illustrating an example of the spoofing determination processing method in an information processing method according to the embodiment.

Note that the operations of each step in the flowcharts of FIGS. 2A to 2D are sequentially performed by the CPU 101a serving as a computer in the information processing apparatus executing a computer program stored in a memory.

### Modification of First Embodiment

In step S201a, an authentication image is acquired by the authentication image acquiring unit 102b. Step S201a functions as an acquiring step of acquiring an image that includes a person to be authenticated.

In step S202a, a process of calculating a contribution region in face authentication is performed on the recognition image acquired in step S201a. Here, step S202a functions as a specifying step of specifying a contribution region in an image to be used for authentication of a person.

A specific processing example in step S202a will be explained with reference to FIG. 2B. Note that FIG. 2B is performed by the authentication contribution region determination unit 103b.

In step S201b of FIG. 2B, a mask region is extracted from the authentication image. In step S202b, a sunglasses region is extracted from the authentication image. The mask region and the sunglasses region are extracted using a neural network and the like that have been learned to segment the mask region and the sunglasses region. However, the extraction method of the mask region and the sunglasses region is not limited thereto.

In step S203b, face authentication of the authentication image is performed. Specifically, the registered images are acquired from the registered image acquiring unit 101b, and the degree of similarity with the authentication image is calculated for each registered image. In step S204b, the upper N registered images having high similarities and similarities are specified by using the similarity for each registered image obtained in step S203b.

Alternatively, when sorting the registered images by degree of similarity, if a difference between consecutive similarity values is equal to or greater than a predetermined value, a registered image before the difference appears may be used. Alternatively, only the highest similarity degree may be used. Note that the selection method of the upper level in similarities is not limited thereto.

Step S205b is the start of the loop of the upper level in search. It is assumed that numbers are assigned to the registered images obtained in step S204b in order from 1. To refer to these numbers by using a variable “i”, “i” is first initialized to 1.

If “i” is equal to or less than the predetermined number of upper registered images, the process proceeds to step S206b, and if i is greater than the predetermined number of upper registered images, the process proceeds to step S208b through step S207b, which is the end of the loop.

In step S206b, a basis region that determines the degree of similarity between the i-th registered image and the authentication image is obtained. The method described in Document 1 and the like may be used as a calculating method of the basis region. Step S207b is the end of the loop of the upper level in search, and the process returns to step S205b after adding 1 to variable i.

In step S208b, the mask region obtained in step S201b, the sunglasses region obtained in step S202b, and the basis region obtained for each registered image in step S206b are integrated. A specific processing example of step S208b will be explained with reference to the flowchart of FIG. 2D.

Note that, in the first embodiment, the mask region, the sunglasses region, and the basis region are binary mask images. The binary mask image is an image having a value of 0 or 1 for each pixel and is an image having a value of 1 when the pixel is in the corresponding region.

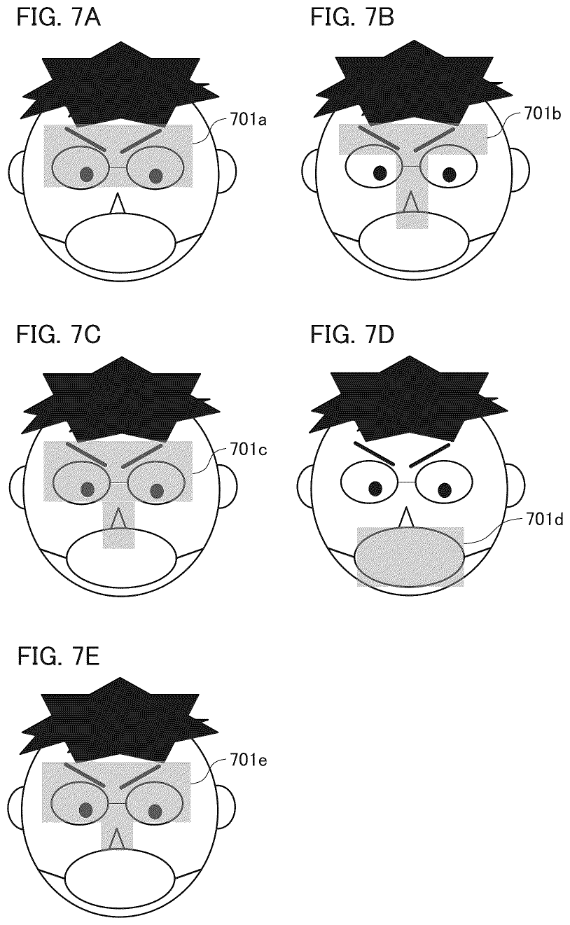

In step S201d of FIG. 2D, the basis regions obtained in step S206b are integrated. FIGS. 7A to 7E are explanatory diagrams of a creation example of the contribution region in the embodiment. For example, in a case in which two basis regions 701a and 701b as shown in FIGS. 7A and 7B are obtained in step S206b, a region obtained by taking a logical sum of the two binary masks is obtained.

That is, a binary mask is created in which a pixel having a value of 1 in either one of the two regions is set to 1. As a result, an integrated basis region 701c as shown in FIG. 7C is obtained.

In step S202d, a process of excluding the mask region obtained in step S201b and the sunglasses region obtained in step S202b from the integrated basis region 701c is performed. For example, it is assumed that the mask region 701d as shown in FIG. 7d has been obtained. It is assumed that because sunglasses are not worn, a sunglasses region has not been obtained.

The fact that no region has been obtained means that the binary mask of the sunglasses region is all zero. Accordingly, in this case, the mask region 701d is excluded from the integrated basis region 701c.

Specifically, when the binary mask indicating the mask region has a value of 1, a process of setting the pixels of the integrated basis region to zero is performed. As a result, the contribution region 701e as shown in FIG. 7E is obtained in step S202d.

When the process of step S202d ends, the process of step S208b ends, and the step S202a of FIG. 2A ends. Next, in step S203a, the spoofing determination region is created using, for example, the contribution region 701e as shown in FIG. 7E that has been obtained in step S202a.

In this context, step S203a functions as a determination step of determining the determination region used for the spoofing determination processing based on the contribution region that has been specified by step S202a serving as a specific step.

The specific process of step S203a will be explained with reference to the flowchart of FIG. 2C. Note that the process of FIG. 2C is performed by the spoofing determination region determination unit 104b.

In step S201c, a spoofing characteristic region is detected. Specifically, the spoofing characteristic region is extracted using a neural network and the like that have been trained to segment a region in which reflection, wrinkles, peeling, dirt, and the like other than in the eye region are present. However, the extraction method of spoofing characteristic region is not limited thereto.

In step S202c, a spoofing erroneously determined region is detected. Specifically, a region in which the blur is strong, a region in which the brightness condition is unfavorable such as too bright or too dark is detected. As a method of detecting a region in which the blur is strong, for example, regions may be sequentially cut out by window shift, a Laplacian filter may be applied, and if the variance of Laplacian values in the region is equal to or less than a predetermined value, it may be determined that the region has a strong blur.

Additionally, as a method of detecting a region in which the brightness condition is unfavorable, regions may be sequentially extracted through window shift, and the region may be determined as having unfavorable brightness conditions if a variance of the brightness histogram for the region is small or if the average brightness of the region is too high or too low. However, the method of extracting the spoofing erroneous determination region is not limited thereto.

In step S203c, the contribution regions obtained in step S202a are corrected and integrated by using each of the spoofing characteristic region obtained in step S201c and the spoofing erroneous determination region obtained in step S202c. Specifically, the contribution regions are integrated by adding the spoofing characteristic region to the contribution regions and removing the spoofing erroneous determination region from the contribution regions.

When the process of step S203c ends, the process of step S203a in FIG. 2A ends. In step S204a, the first spoofing determination unit 105b performs spoofing determination using the spoofing determination region that has been obtained in step S203c.

In this context, the first spoofing determination unit 105b functions as a first spoofing determination unit that determines whether or not the image is an attack attempting unauthorized authentication, based on the determination region.

In this context, the step S204a functions as a spoofing determination step of executing spoofing determination processing for determining spoofing based on the determination region that has been determined by the determination step.

In the first embodiment, a method of combining two methods of a heuristic method and a method of obtaining a basis region has been described, as a method of obtaining a contribution region to be obtained by the recognition contribution region determination unit 103b.

Specifically, the example in which the method of removing the region that does not contribute to the face authentication from the contribution region by the heuristic method and the method of obtaining the basis region that determines the degree of similarity between the registered image and the authentication image are combined has been explained. However, a method using only one of the two methods may be employed. It is possible to speed up the processing by narrowing down to only one method. The determination method of the contribution region is not limited thereto.

Additionally, in the first embodiment, an example of acquiring a plurality of registered images from the registered image acquiring unit 101b has been explained. However, a configuration in which only one registered image is acquired from the registered image acquiring unit 101b may be adopted. Alternatively, a configuration in which the registered image acquiring unit 101b is not present may be adopted.

In this case, the processes of steps S203b to S207b in FIG. 2B performed by the recognition contribution region determination unit 103b is omitted. Therefore, a region excluding the region of the mask and sunglasses may be used as the contribution region. At this time, the face region may be segmented, and then a region excluding the mask and sunglasses region from the face region may be set as the contribution region.

Additionally, in the first embodiment, the spoofing determination region determination unit 104b obtains the spoofing determination region by correcting the contribution region. However, the contribution region may directly be used as the spoofing determination region.

Additionally, in the first embodiment, the mask region, the sunglass region, and the basis region in the processes of FIG. 2B are explained as binary masks. However, the image may have a continuous value of 0 to 1 for each pixel.

In this case, the processes of FIG. 2D may be performed after converting the region into a binary mask by performing threshold processing on the mask region, the sunglass region, or the basis region. Alternatively, in step S201d, an average may be obtained for each pixel of the plurality of basis regions, and pixels exceeding a threshold may be used as the integrated basis region.

Additionally, in the first embodiment, the contribution region has been explained as a region having no value. However, a contribution score indicating a degree of contribution for each pixel of the contribution region may be provided. For example, the mask region, the sunglasses region, and the basis region obtained in each of steps S201b, S202b, and S206b may have contribution score values for each pixel.

Then, in the integration of the regions of step S208b, the regions may be integrated by addition, subtraction, and the like of the values of each region. For example, a plurality of basis regions obtained in step S206b are integrated into one basis region by averaging the values for each pixel.

Subsequently, the contribution region may be obtained by subtracting the values of the mask region and the sunglass region from the basis region after the integration. Note that the mask region, the sunglasses region, and the like may be weighted and then subtracted. Note that the integration processing of the region is not limited thereto.

Similarly, the spoofing determination region obtained by the spoofing determination region determination unit 104b may have a value. The spoofing characteristic region obtained in step S201c and the spoofing erroneous determination region obtained in step S202c may also be regions having a value for each pixel.

In this kind of case, in the integration process of the regions in step S203c, the spoofing characteristic region may be weighted and added from the contribution region, and further, the spoofing erroneous determination region may be weighted and subtracted. The region integration processing is not limited to these.

Additionally, if the spoofing erroneous determination region has a value, and the “method of obtaining the spoofing score of the image” is used in the first spoofing determination unit 105b, the input image may be created by, for example, blackening the pixels of the authentication image in which the value of the spoofing determination region is less than a predetermined value.

Alternatively, the brightness of the input image may be changed depending on the magnitude of the value. Alternatively, a neural network to which the spoofing determination region having a value and the authentication image are input may be learned.

In contrast, if the “method of obtaining a spoofing score for each region of the image” is used, the spoofing score of the image may be obtained by obtaining a statistic such as an average after weighting the spoofing determination score with the value of the spoofing determination region as a weight. The method of spoofing determination using the spoofing determination region having a value is not limited thereto.

In the above-described embodiment, when the first spoofing determination unit 105b obtains a result of spoofing determination in step S204a, the determination result is displayed on the monitor 110a and the like as an image display unit to notify the user. Alternatively, the spoofing determination result is recorded in the RAM 103a and the external storage device 104a.

The usage method of the spoofing determination result is not limited thereto. Additionally, a spoofing score may be obtained as the spoofing determination result. Alternatively, the threshold processing may be performed on the spoofing score, and a case in which the spoofing score exceeds a predetermined threshold may be determined as “attack”, and the other cases may be determined as “non-attack”. The spoofing determination result is not limited thereto.

By doing as described above, it is possible to perform spoofing determination focusing on a region that affects authentication. If there is a spoofing of printed material and the like in a region that affects authentication, the result of authentication is distorted in an unauthorized manner. In contrast, even if there is an object that shields the skin, the authentication result is not distorted by the shielding object if the shielding object is outside the region that affects the authentication.

Therefore, spoofing determination focusing on a region that affects authentication is effective. In particular, shielding the skin with a mask, sunglasses, glasses, face paint, beard, and the like are performed on a daily basis, and there is an effect that it is possible to suppress erroneous determination of spoofing due to such a wearable object.

In addition, the region used for spoofing determination is corrected by the spoofing determination region determination unit 104b. That is, by adding a clear spoofing characteristic region, for example reflection, wrinkles, peeling, and dirt other than the eye region to the spoofing determination region, an effect of preventing a determination omission of spoofing is obtained.

In addition, because a region in which the blur is strong, a region in which the brightness is too bright or too dark, and the like induce erroneous determination of spoofing, these spoofing erroneous determination regions are removed from the spoofing determination region, thereby obtaining an effect of preventing spoofing erroneous determination.

### Second Embodiment

In the second embodiment, the determination result, the image, and the like are stored after the spoofing determination, and are presented to the user. Additionally, machine learning of detection of a “spoofing characteristic region” and a “spoofing erroneous determination region” used in the spoofing determination region determination unit 104b is performed by using the stored data.

A configuration of the information processing apparatus 300 of the second embodiment will be explained with reference to the block diagram of FIG. 3A. FIG. 3A is a functional block diagram illustrating a configuration example of the information processing apparatus 300 according to the second embodiment. The difference from the first embodiment is that components 306a to 311a are added.

The second spoofing determination unit 306a performs spoofing determination by using the entire face region. Specifically, the spoofing determination is performed by the methods described in Documents 2 to 4 as described above. The second spoofing determination unit 306a is characterized in that the second spoofing determination unit 306a performs spoofing determination without being limited to the contribution region, whereas the first spoofing determination unit 105b uses the contribution region of the face authentication.

Note that the second spoofing determination unit 306a functions as a second spoofing determination unit that determines whether or not the image is an image (attack) attempting unauthorized authentication, based on the acquired image. Note that, in the second embodiment, although the entire region is used, it is not always necessary to use the entire region. For example, a configuration may be adopted in which determination is performed by excluding a region that induces erroneous determination by a criterion for such as blur.

However, the configuration of the second spoofing determination unit 306a is not limited thereto. Note that, in the second embodiment, it is assumed the first spoofing determination unit 105b and the second spoofing determination unit 306a obtain “attack” or “non-attack” as the spoofing determination result.

An attack region creating unit 307a creates an attack region. The attack region is a region indicating an attack object. For example, in the case of an authentication image in which an attacker holds a photograph of another person's mouth, data indicating a photograph region held over the mouth is set as an attack region.

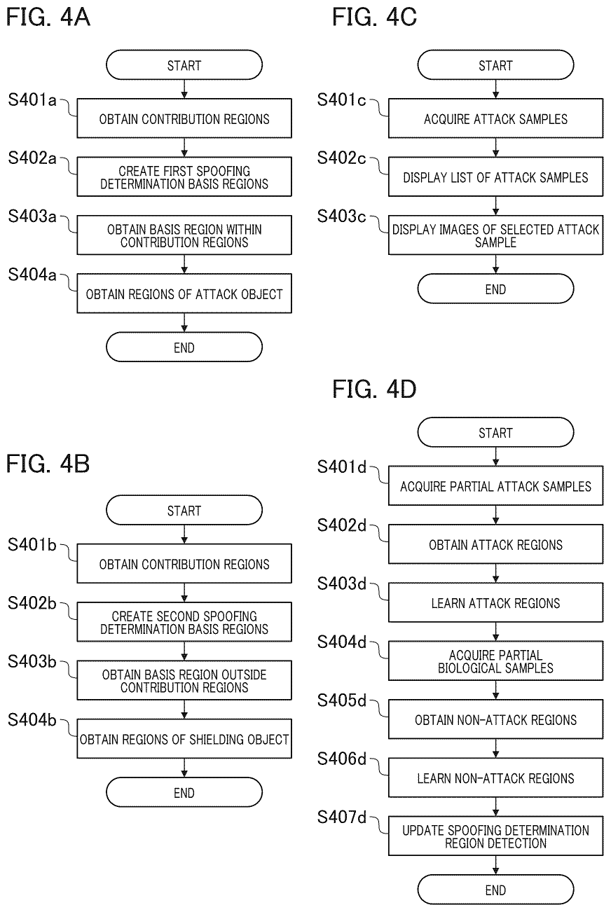

Note that the attack region creating unit 307a functions as an attack region creating unit that creates an attack region based on the contribution region. The processing of the attack region creating unit 307a will be described in detail below with reference to FIG. 4A.

A non-attack region creating unit 308a creates a non-attack region. The non-attack region is a region indicating a shielding object that is not intended to be attacked, and is, for example, a region indicating a shielding object that is not intended to be attacked, for example, a mask, sunglasses, eyeglasses, face paint, and a beard. Note that the shielding object includes at least one of a mask, sunglasses, eyeglasses, face paint, and a beard.

The non-attack region creating unit 308a functions as a non-attack region creating unit that creates a non-attack region based on the contribution region. The processing in the non-attack region creating unit 308a will be described in detail below with reference to FIG. 4B.

An image storage unit 309a stores the spoofing determination result.

Specifically, the first and second spoofing determination results, the image data, the attack region data, the non-attack region data, and the like are stored. In this context, the image storage unit 309a functions as an image storage unit that stores the image, the determination result of the first spoofing determination unit, and the determination result of the second spoofing determination unit.

In particular, the image storage unit 309a stores the attack region data when the first spoofing determination result is “attack” and the second spoofing determination result is “non-attack”. Consequently, it is possible to store attack region data that may induce an erroneous determination in the second spoofing determination.

Additionally, the non-attack region data is stored when the first spoofing determination result is “non-attack” and the second spoofing determination result is “attack”. Consequently, it is possible to store non-attack region data that may induce an erroneous determination in the second spoofing determination.

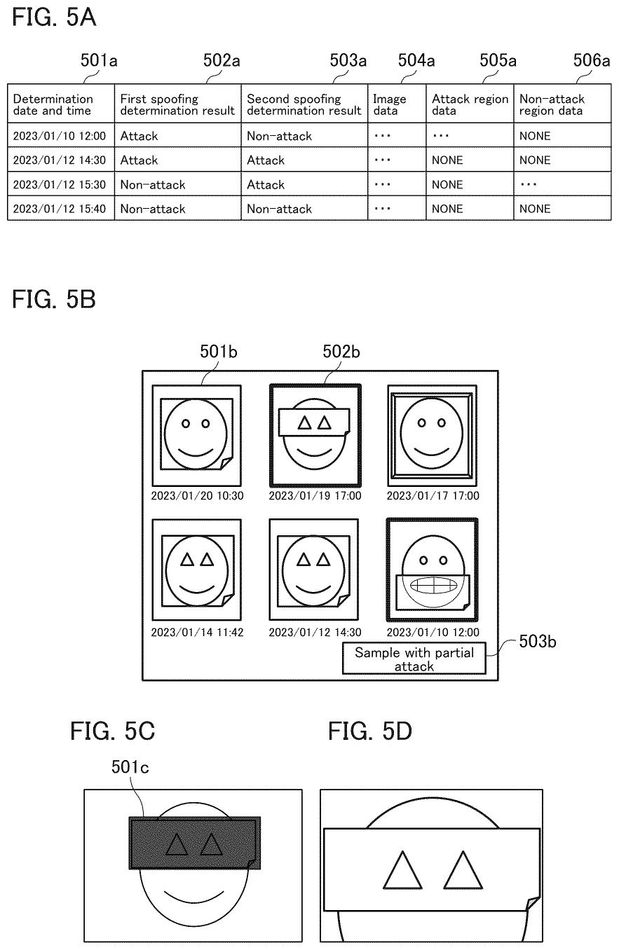

The stored contents will be described in detail below with reference to FIG. 5A. Note that in the second embodiment, although these data are stored in the external storage device 104a, a configuration in which these data are stored in the RAM 103a, and the like may be adopted.

An image display unit 310a performs processing for displaying data stored in the image storage unit 309a. In the second embodiment, data in which the first spoofing determination result is determined to be “attack” is displayed on the monitor 110a.

In particular, data determined as “attack” in the first spoofing determination result but determined as “non-attack” in the second spoofing determination result is displayed in a highlighted manner. This is because data in which both the first and second results are “attack” is often a normal attack in which a photograph of another person's face and the like is presented.

In contrast, data in which the first result is “attack” and the second result is “non-attack” is a more sophisticated attack such as holding a photograph cut out of another person's mouth over the mouth of the attacker. In order to warn the user of such a sophisticated attack, these data are displayed in a more emphasized manner. The details of the processing will be described below with reference to FIG. 4C.

A spoofing determination region detection learning unit 311a performs machine learning of detection of a “spoofing characteristic region” and a “spoofing erroneous determination region” used by the spoofing determination region decision unit 104b. Specifically, learning is performed by using the attack region data and the non-attack region data stored in the image storage unit 309a so that these regions can be segmented (cut out) by a neural network and the like.

The spoofing determination region determination unit 104b operates to detect the “spoofing characteristic region” and the “spoofing erroneous determination region” by using the machine-learned detecting unit. The detailed processing will be described below with reference to FIG. 4D.

FIG. 3B is a flowchart illustrating an example of the spoofing determination processing according to the second embodiment, and FIG. 3C is a flowchart illustrating a detailed processing example of step S305b.

Note that the CPU 101a serving as a computer in the information processing apparatus executes a computer program stored in the memory, thereby sequentially performing the operations of the steps in the flowcharts of FIG. 3B and FIG. 3C.

The flow of FIG. 3B is obtained by adding step S305b of storing data at the end to the flow of the spoofing determination processing of FIG. 2A of the first embodiment. The details of step S305b will be described with reference to FIG. 3C.

In step S301c of FIG. 3C, the second spoofing determination unit 306a performs the second spoofing determination processing on the authentication image.

In step S302c, it is determined whether or not only the first spoofing determination result is “attack”. Specifically, when the first spoofing determination result is “attack” and the second spoofing determination result is “non-attack”, the determination result is “YES”, and the process proceeds to step S303c. Otherwise, the process proceeds to step S304c.

In step S303c, the attack region creating unit 307a creates an attack region. FIGS. 4A to 4D are flowcharts illustrating the flow of the display processing and the learning processing in the second embodiment, and FIG. 4A is a flowchart illustrating the flow of the processing in step S303c in the second embodiment.

Note that the CPU 101a serving as a computer in the information processing apparatus executes a computer program stored in the memory, thereby sequentially performing the operations of the steps in the flowcharts of FIGS. 4A to 4D.

In step S401a, the contribution region created in step S202a is acquired. In step S402a, the basis region of the determination result obtained by the first spoofing determination unit 105b in step S203a is obtained, and a first spoofing determination basis region is created.

For example, as a typical method for obtaining a ground truth region of a neural network, there is a method described in Document 5 (R. R. Selvaraju, M. Cogswell, A. Das, R. Vedantam, D. Parikh and D. Batra, “Grad-CAM: Visual Explanations from Deep Networks via Gradient-Based Localization,” 2017 IEEE International Conference on Computer Vision (ICCV), Venice, Italy, 2017, pp. 618-626).

In step S402a, the first spoofing determination basis region is created by performing threshold processing on the basis region obtained using GradCAM and the like described in Document 5. Note that the method of creating the first spoofing determination basis region is not limited thereto.

In step S403a, a basis region within the contribution region is obtained. Consequently, it is possible to obtain the basis region that is the basis of the spoofing that has affected the authentication.

In step S404a, the region of the attack object (attack region) is obtained based on the basis region that has been obtained in step S403a. For example, the region may be expanded by obtaining a contour, an edge, and the like surrounding the region obtained in step S403a.

Alternatively, after the region is divided into small regions by an edge and the like, ranges having similar color tones may be connected to each other in the region obtained in step S403a by using a color histogram and the like, and the region of the attack object (attack region) may be expanded.

Alternatively, a segmentation region may be obtained by a neural network that has learned segmentation of general objects, and a region of an attacking object (attacking region) may be obtained by using the segmentation region that includes the region obtained in step S403a.

That is, the apparatus may include a learning means for learning a detection means for detecting spoofing determination regions from among images stored in the storage means for which the first spoofing determination means determined “attack” and the second spoofing determination means determined “non-attack”. Additionally, the determination of regions may be performed by using the detection means learned by the learning means.

However, the method of acquiring the region of the attack object is not limited thereto. After the process of step S404a, the flow of FIG. 4A ends, step S303c of FIG. 3C ends, and the process proceeds to step S304c.

In step S304c, it is determined whether or not only the first spoofing determination result is “non-attack”. When the first spoofing determination result is “non-attack” and the second spoofing determination result is “attack”, the determination result is “YES”, and the process proceeds to step S305c.

Otherwise, the process proceeds to step S306c. In step S305c, the non-attack region creating unit 308a creates a non-attack region. A detailed example of the process in step S305c will be explained with reference to FIG. 4B.

In step S401b of FIG. 4B, the contribution region created in step S202a is obtained. In step S402b, a second spoofing determination basis region is created by obtaining a basis region of the determination result that has been obtained by the second spoofing determination unit S306a in step 301c. In step S402b, the spoofing determination basis region may be obtained by GradCAM and the like in a manner similar to step S402a.

In step S403b, a basis region outside the contribution region is obtained. Accordingly, it is possible to obtain a region that does not affect authentication but is likely to be determined as spoofing. In step S404b, the region of the shielding object is obtained based on the region that has been obtained in step S403b.

Also in step S404b, the region of the shielding object is obtained by, for example, expanding the region of the shielding object using a method similar to the region expansion method described in step S404a. Then, it is assumed that the region other than the region of the shielding object in the image of the person to be authenticated is set as the contribution region. After the process of step S404b, the flow in FIG. 4B ends, step S305c in FIG. 3C ends, and the process proceeds to step S306c.

In step S306c, the determination result is stored and displayed in the image storage unit 309a. Specifically, first, data for one row of the table shown in FIG. 5A is stored. FIGS. 5A to 5D are diagrams illustrating examples of a data format and display stored in step S306c of the second embodiment.

FIG. 5A shows an example of data held in the image storage unit 309a. In a determination date and time 501a, the date and time when the processing of FIG. 3B is performed is held. In a first spoofing determination result 502a, the determination result obtained in step S203a is held.

In a second spoofing determination result 503a, the determination result obtained in step S301c is held. In image data 504a, the authentication image obtained by the authentication image acquiring unit 102b processed in the flow of FIG. 3B is held.

In attack region data 505a, the attack region obtained in step S303c is held. In non-attack region data 506a, the non-attack region obtained in step S305c is held. Note that, in the columns 505a and 506a, “NONE” indicates that the corresponding data is not present.

Next, the attack image display processing in step S306c of the second embodiment will be explained with reference to FIG. 4C. Note that the display of the processing in FIG. 4C is performed on the monitor 110a and the like, and an operation that includes pressing a button on the screen is performed by a mouse and the like connected to the input device 109a.

In step S401c, an attack sample is acquired from the image storage unit 309a. Specifically, a record in which the determination result of the first spoofing determination result 502a in FIG. 5A is “attack” is obtained.

In step S402c, the attack samples obtained in step S401c are displayed. Specifically, the attack samples are displayed as shown in the display example of FIG. 5B. Reference numerals 501b and 502b denote attack samples, and these attack samples are displayed in the order of the Z-shape from the upper left of the screen in order from the latest determination date.

In the display of FIG. 5B, the frame of the attack sample is thickened to emphasize the sample whose second spoofing determination result is “non-attack”. That is, because the second spoofing determination result is “attack”, the frame of the attack sample 501b is not thick.

In contrast, because the second spoofing determination result of the attack sample 502b is “non-attack”, the frame is thickened. Specifically, when the image display unit displays the image determined to be an attack by the first spoofing determination unit, the image determined to be a non-attack by the second spoofing determination unit is highlighted.

With such highlight, a more highlighted display can be made for a sophisticated attack that causes the second spoofing determination result to be erroneously determined, and a warning can be issued to the user. Additionally, when the user presses down (clicks) a button 503b labeled “partial attack”, the attack samples are narrowed down to those with a thick frame and visualized for the user.

Note that the method of highlighting the sample in which the first spoofing determination result is “attack” but the second spoofing determination result is “non-attack” is not limited to the above example.

In step S403c, when the user selects a part of the attack samples shown in step S402c, the selected sample is displayed on the screen in more detail. For example, when the attack sample 502b in FIG. 5B is selected, the attack sample 502b is displayed as shown in FIG. 5C.

An attack region 501c is a visualization of the attack region data in FIG. 5A. In this example, a sheet on which the eyes of another person are printed is held in front of the face. The paper region of the eyes is colored and displayed as the attack region 501c.

Furthermore, when the user selects the attack region 501c with a mouse and the like, the attack region 501c may be enlarged and displayed as shown in FIG. 5D. Consequently, it is possible to observe in detail what material the paper region of the eyes is made of.

Additionally, the attack region may be surrounded by a red line, instead of coloring the attack region. Additionally, when the user selects the attack sample 502b, an enlarged display as shown in FIG. 5D may be performed. The method of displaying the attack region is not limited thereto.

Next, an example of the learning processing of the spoofing determination region detection in the spoofing determination region detection learning unit 311a of the second embodiment will be explained with reference to FIG. 4D. Note that the processes in FIG. 4D are executed when the user instructs learning via the input device 109a and the like.

Alternatively, the processes may be executed when the data amount of the image storage unit 309a exceeds a predetermined amount. However, the execution timing of the learning processing in FIG. 4D is not limited thereto.

In step S401d, a partial attack sample is acquired from the image storage unit 309a. Specifically, a record in which the first spoofing determination result 502a is “attack” and the second spoofing determination result is “non-attack” in FIG. 5A is obtained.

In step S402d, the image data 504a and the attack region data 505a of the record obtained in step S401d are acquired. In step S403d, the attack region is learned using the data obtained in step S402d.

That is, the learning unit learns the detection unit so that the attack region is detected. Specifically, the region detecting unit may be caused to learn segmentation in which image data is input and attack region data is output by a neural network and the like.

In step S404d, a partial biological sample is obtained from the image storage unit 309a. Specifically, for example, a record in which the first spoofing determination result 502a is “non-attack” and the second spoofing determination result is “attack” in FIG. 5A is obtained.

In step S405d, the image data 504a and the non-attack region data 506a of the record obtained in step S404d are acquired. In step S406d, the non-attack region is learned by using the data obtained in step S405d.

That is, the learning unit learns the detection unit so that the non-attack region is detected. Specifically, the region detection unit may be caused to learn segmentation in which image data is input and non-attack region data is output by a neural network and the like.

Thus, the detection unit of the spoofing determination region is learned by the learning unit by using the image in which a “non-attack” is determined by the first spoofing determination unit and an “attack” is determined by the second spoofing determination unit among the images stored in the image storage unit.

In step S407d, the detection method (determination method) of the spoofing determination region determination unit 104b is updated. Specifically, the region detection unit learned in step S403d is used for detection of a spoofing characteristic region in step S201c in FIG. 2C.

That is, in step S201c, although a spoofing characteristic region such as reflection is detected, a region obtained by the region detection unit learned in step S403d is also detected, and these regions are added to the spoofing characteristic determination region.

Similarly, the region detection unit learned in step S406d is used in step S202c in FIG. 2C. Specifically, in step S202c, the spoofing erroneous determination region such as blur is detected, and in addition, the region obtained by the region detection unit learned in step S406d is also detected, and these regions are excluded from the spoofing characteristic determination region.

Note that although only the attack samples are visualized in the above embodiment, the non-attack samples may also be visualized. That is, a sample in which the first spoofing determination result is “non-attack” may be visualized.

In particular, only non-attack samples in which the first spoofing determination result is “non-attack” but the second spoofing determination result is “attack” may be displayed. Consequently, it is possible to know what kind of wearable object is likely to induce spoofing erroneous determination.

Additionally, as shown in FIG. 5C, the non-living body region may be displayed. Consequently, it becomes easier to find where the non-living body region that is likely to induce the spoofing erroneous determination is located in the face.

Similarly, the non-living body region may be enlarged and displayed as in the case in which the attack region is enlarged and displayed in FIG. 5D. As a result, it is possible to observe in detail the material of the non-living body region that is likely to induce spoofing erroneous determination.

In the second embodiment, although image display and the like are performed after image storage, only image storage may be performed. In this case, the image display unit 310a and the spoofing determination region detection learning unit 311a are unnecessary. Additionally, a configuration in which the attack region and the non-attack region are not stored may be adopted, and in this case, the attack region creating unit 307a and the non-attack region creating unit 308a are not necessary.

Alternatively, the samples to be stored in the image storage unit 309a may be limited to a part of the samples. For example, a sample in which the first spoofing determination result is a “non-attack”, and the second spoofing determination result is a “non-attack” may not be stored in the image storage unit 309a.

Because such clear biological samples occur in large numbers through operation of the system, capacity can be conserved by not storing such data. Furthermore, only when the first spoofing determination result and the second spoofing determination result are different from each other, the data may be stored.

Alternatively, only samples of a sophisticated attack such as the first spoofing determination result is “attack” but the second spoofing determination result is “non-attack”may be stored. However, the method of selecting the samples to be stored is not limited thereto.

Note that, in the second embodiment, although both “display of attack image” and “learning of spoofing determination region detection” are performed, a configuration in which only one of these is performed may be adopted. When “display of attack image” is not performed, the image display unit 310a is unnecessary.

In addition, if the sample of the living body is not displayed, the processes of step S304c, step S305c, and the like may be omitted. Similarly, when “learning of the spoofing determination region detection” is not performed, the spoofing determination region detection learning unit 311a is unnecessary.

Additionally, in the second embodiment, although both “learning of attack region” and “learning of non-attack region” are performed in “learning of spoofing determination region detection”, only one of these may be performed.

In a case in which “learning of the attack region” is not performed, steps S401d to S403d can be omitted. In a case in which “learning of the non-attack region” is not performed, steps S404d to S406d can be omitted.

In the embodiments as explained above, cases are utilized in which the results differ between normal spoofing determination (second spoofing determination) and spoofing determination based on the contribution region (first spoofing determination).

As a result, it is possible to extract a sophisticated attack sample (partial attack such as presenting a photograph of another person's mouth only for the mouth) that may be missed by normal spoofing determination.

By preferentially displaying the extraction result, it is possible to warn the user of a sophisticated attack in a more emphasized manner. Additionally, by learning the attack regions of these sophisticated attack samples, spoofing characteristic regions that serve as indicators for spoofing determination can be extracted. Furthermore, it is possible to reduce overlooking of the spoofing determination by adding this region to the determination region of the first spoofing determination.

In addition, it is possible to extract a non-attack sample having a decorative object that causes erroneous detection in normal spoofing determination. It is possible to extract a region that induces erroneous determination in the spoofing determination by learning the non-attack region of the non-attack sample. Additionally, by excluding this region from the determination region in the first spoofing determination, it is possible to reduce erroneous determination in the spoofing determination.

### Third Embodiment

The third embodiment is configured so that the first spoofing determination is performed in a case in which the “attack” is determined by the second spoofing determination. Note that the configuration of the information processing apparatus according to the third embodiment may be similar to that according to the second embodiment. Alternatively, referential numerals 307a to 311a may be omitted.

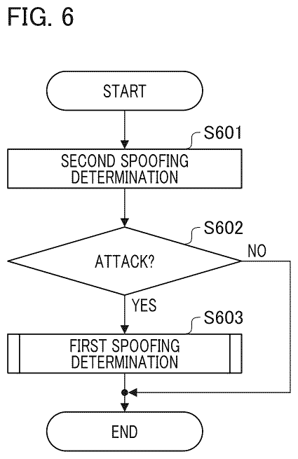

The spoofing determination processing in the third embodiment will be explained with reference to FIG. 6. FIG. 6 is a flowchart illustrating the flow of the spoofing determination processing in the third embodiment.

The CPU 101a serving as a computer in the information processing apparatus executes a computer program stored in the memory, thereby sequentially performing the operations of the steps in the flowchart of FIG. 6.

In step S601, the second spoofing determination unit 306a performs spoofing determination. In step S602, it is determined whether or not the determination result in step S601 is “attack”. If the determination result is “attack”, the process proceeds to step S603. Otherwise, the flow of FIG. 6 ends.

In step S603, the spoofing determination processes as shown in FIG. 3B are performed. Note that a configuration in which the data storage processing of step S305b is not performed may be adopted. As described above, in the third embodiment, the first spoofing determination is performed only when “attack” is determined in the second spoofing determination in step S602. That is, the first spoofing determination unit performs spoofing determination when attack is determined by the second spoofing determination unit, and thus the processing can be made efficient.

Note that, in step S204a, a configuration may be adopted in which spoofing is determined when the area of the contribution region obtained in step S202a is smaller than a predetermined threshold. That is, an attack may be determined when the area of the contribution region is equal to or less than a predetermined value. At that time, the area may be calculated after performing threshold processing and the like on the contribution region.

This is because in cases such as when a mask, sunglasses, and hat are worn and the skin region is barely visible, because such a person is suspicious even when a spoofing region is not present in the contribution region, it is better to determine this as spoofing. As a result, it is possible to reduce erroneous determination caused by spoofing determination using only a slightly visible region.

Additionally, although the above-described embodiments had detection of spoofing in face authentication as an objective, other biometric authentication may be used. For example, spoofing may be detected for other biometric authentication such as iris authentication and fingerprint authentication.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing apparatus and the like through a network or various storage media. Then, a computer (or a CPU, an MPU, or the like) of the information processing apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-009316, filed on Jan. 25, 2024, which is hereby incorporated by reference herein in its entirety.

What is claimed is:

1. An information processing apparatus comprising:
at least one processor; and a memory coupled to the at least one processor, the memory storing instructions that, when executed by the at least one processor, cause the at least one processor to:
acquire an image that includes a person to be authenticated;
identify a contribution region within the image to be used in authenticating the person;
determine a determination region to be used for spoofing determination processing based on the identified contribution region; and
execute the spoofing determination processing for determining spoofing based on the determination region.

2. The information processing apparatus according to claim 1, wherein the determination region is determined by adding a spoofing characteristic region, which has a spoofing characteristic, to the contribution region.

3. The information processing apparatus according to claim 2, wherein the spoofing characteristic region includes at least one of reflection, wrinkles, peeling, and dirt of the image of the person to be authenticated.

4. The information processing apparatus according to claim 1, wherein the determination region is determined by excluding, from the contribution region, a spoofing erroneous determination region corresponding to a predetermined condition that induces erroneous determination in spoofing determination.

5. The information processing apparatus according to claim 4, wherein the spoofing erroneous determination region is excluded from the determination region based on blur or brightness of the image of the person to be authenticated.

6. The information processing apparatus according to claim 1, wherein a region other than a region of a shielding object in the image of the person to be authenticated is set as the contribution region.

7. The information processing apparatus according to claim 1, wherein the memory storing further instructions that, when executed by the at least one processor, cause the at least one processor to:
acquire a registered image of the person to be authenticated; and
determine the contribution region based on a region that contributes to determination of the similarity between the registered image and the image acquired by the acquiring.

8. The information processing apparatus according to claim 7, wherein an image of a person who is not wearing a shielding object is acquired as the registered image.

9. The information processing apparatus according to claim 1, wherein a first spoofing determination for determining whether or not the image is an attack attempting unauthorized authentication is performed based on the determination region.

10. The information processing apparatus according to claim 9, wherein in the first spoofing determination, attack is determined if an area of the contribution region is equal to or less than a predetermined value.

11. The information processing apparatus according to claim 9, wherein a second spoofing determination for determining whether or not the image is an attack attempting unauthorized authentication is performed based on the acquired image.

12. The information processing apparatus according to claim 11, wherein the first spoofing determination is performed when the second spoofing determination determines that the image is an attack.

13. The information processing apparatus according to claim 11, further configured to perform image storage processing to store the image, a determination result of the first spoofing determination, and a determination result of the second spoofing determination.

14. The information processing apparatus according to claim 13, further configured to perform learning processing to learn detection processing for detecting the determination region by using images determined to be an attack in the first spoofing determination and determined to be a non-attack in the second spoofing determination, among the images stored by the image storage processing; wherein the determination is performed by using the detection processing of the determination region obtained through the learning processing.

15. The information processing apparatus according to claim 14, further comprising attack region creation processing that creates an attack region based on the contribution region, and
wherein the learning processing learns the detection processing so as to detect the attack region.

16. The information processing apparatus according to claim 13, further configured to perform learning processing to learn detection processing for detecting a spoofing determination region by using images determined to be a non-attack in the first spoofing determination and determined to be an attack in the second spoofing determination, among the images stored by the image storage processing.

17. The information processing apparatus according to claim 16,
further comprising non-attack region creation processing that creates a non-attack region based on the contribution region, and
wherein the learning processing learns the detection processing so as to detect the non-attack region.

18. The information processing apparatus according to claim 13, further comprising image display processing that highlights an image determined to be a non-attack by the second spoofing determination when displaying an image determined to be an attack by the first spoofing determination.

19. An information processing method comprising:
acquiring an image that includes a person to be authenticated;
identifying a contribution region within the image to be used in authenticating the person;
determining a determination region to be used for spoofing determination processing based on the identified contribution region; and
executing spoofing determination processing for determining spoofing based on the determination region that has been determined.

20. A non-transitory computer-readable storage medium configured to store a computer program comprising instructions for executing following processes:
acquiring an image that includes a person to be authenticated;
identifying a contribution region within the image to be used in authenticating the person;
determining a determination region to be used for spoofing determination processing based on the identified contribution region; and
executing spoofing determination processing for determining spoofing based on the determination region that has been determined.
